(19) United States
(12) Patent Application Publication
(10) Pub. No.: US 2019/0163870 A1
(43) Pub. Date: May 30, 2019

(54) EFFECTIVE PATIENT STATE SHARING

(71) Applicant: INTERNATIONAL BUSINESS MACHINES CORPORATION, Armonk, NY (US)

(72) Inventors: Paul R. Bastide, Boxford, MA (US); Matthew E. Broomhall, Goffstown, NH (US); Robert Loredo, North Miami Beach, FL (US); Fang Lu, Billerica, MA (US)

(21) Appl. No.: 15/826,049

(22) Filed: Nov. 29, 2017

(51) Int. Cl. G06F 19/00; G06K 9/00

(52) U.S. Cl. CPC G06F 19/321; G06F 19/3431; G06Q 50/01; G06F 19/345; G06K 9/00302; G06F 19/322

(57) ABSTRACT

Effective self-assessment, for example of pain, is provided. In various embodiments, one or more image of a patient is read from a designated social media account. One or more patient interest is determined from the designated social media account. One or more additional image is selected based on the one or more patient interest. Sentiments are determined for the one or more image of the patient and the one or more additional image. Based on the sentiments, scores are determined for the one or more image of the patient and for the one or more additional image. The one or more image of the patient and the one or more additional image are displayed to the patient. A selection among the one or more image of the patient and the one or more additional image is received from the patient. The selection is indicative of the patient's self-assessed score.

### BACKGROUND

Embodiments of the present disclosure relate to patient state assessment, and more specifically, to providing effective self-assessment, for example of pain.

### BRIEF SUMMARY

According to embodiments of the present disclosure, methods of and computer program products for patient state assessment are provided. In various embodiments, one or more image of a patient is read from a designated social media account. One or more patient interest is determined from the designated social media account. One or more additional image is selected based on the one or more patient interest. Sentiments are determined for the one or more image of the patient and the one or more additional image. Based on the sentiments, scores are determined for the one or more image of the patient and for the one or more additional image. The one or more image of the patient and the one or more additional image are displayed to the patient. A selection among the one or more image of the patient and the one or more additional image is received from the patient. The selection is indicative of the patient's self-assessed score.

### BRIEF DESCRIPTION OF THE SEVERAL VIEWS OF THE DRAWINGS

FIG. 1 is a general purpose pain scale.

FIG. 2 illustrates a system for patient state assessment according to embodiments of the present disclosure.

FIG. 3 a method for patient state assessment according to embodiments of the present disclosure.

FIG. 4 depicts a computing node according to embodiments of the present disclosure.

### DETAILED DESCRIPTION

A pain scale is used as part of various diagnostic tasks to measure a patient's pain intensity or other features. Pain measurements help determine the severity, type, and duration of the pain, and are used to make an accurate diagnosis, determine a treatment plan, and evaluate the effectiveness of treatment. Specialized pain scales are available for various patient populations, such as neonates, infants, children, adolescents, adults, seniors, and persons whose communication is impaired. Pain assessments are critical for various diagnoses.

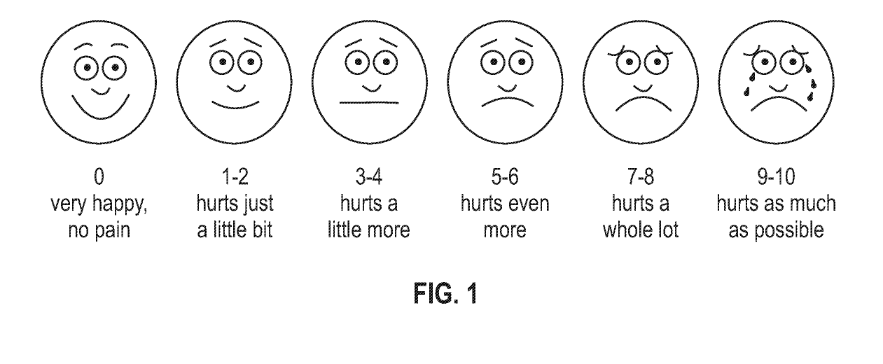

Various illustrative aids may be used to help a patient categorize their pain level. For example, a patient may be asked to look at a scale such as displayed in FIG. 1, and select a numerical rating for their pain. However, self-reporting introduces reliability and reproducibility issues. Each patient may perceive pain differently, and may express it differently. Likewise, a given doctor may conceptualize pain levels differently that a given patient.

Similarly, a doctor may second patient's self-reported pain level in view of his prior experience, or his assessment of the patient's understanding of the scale. Accordingly, the use of a general purpose pain scale can lead to significant misunderstanding, and consequently to suboptimal treatment.

To address these and other shortcomings of alternative approaches, the present disclosure enables effective and accurate sharing of patient state, including pain level. In various embodiments, an input set of images is analyzed to determine their correspondence to a pain index. The input set of images may be drawn from social media of a patient, or may relate to a theme such as a given television program or movie. The input images are correlated to the pain (or other patient state) scale, and presented to the patient. The patient may select among the correlated images to indicate their pain (or other state) level. In this way, additional context is provided to the patient and the doctor in order to facilitate effective assessment and communication.

It will be appreciated that although various examples provided herein relate to pain level, the present disclosure is applicable to a variety of self-assessed patient states. For example, a user may be asked to assess pain, anger, sadness, depression, relief, happiness, or any other self-assessed state.

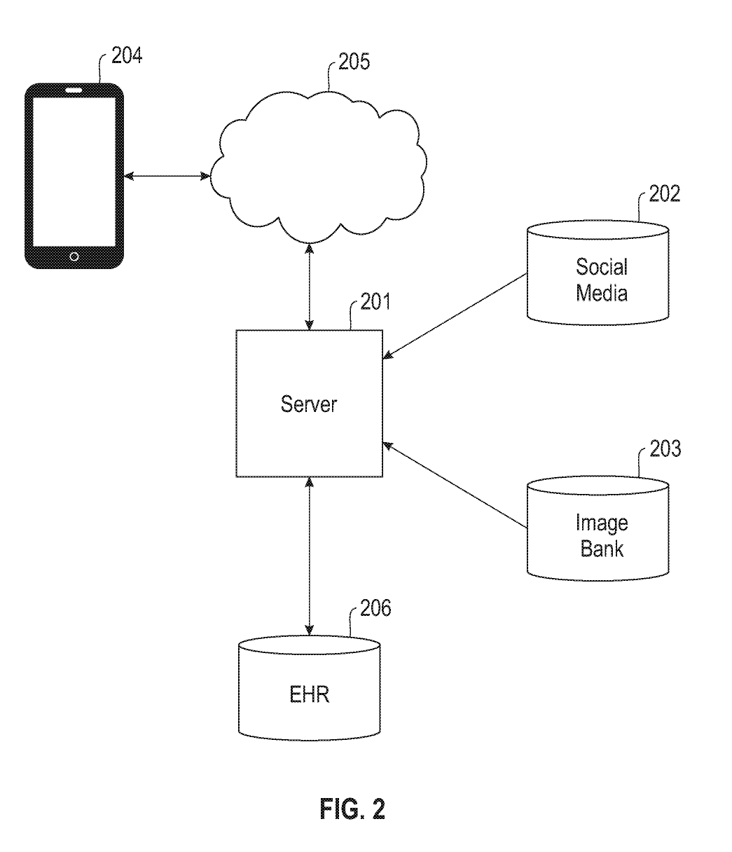

Referring now to FIG. 2, a system for providing patient state evaluation and sharing is illustrated according to embodiments of the present disclosure. In various embodiments, server 201 ingests images of a given patient from social media 202. For example, a patient may register one or more social media accounts with server 201 prior to evaluation, and grant access to server 201 to retrieve images and associated text. In various embodiments, server 201 ingests images from image bank 203. In various embodiments, image bank 203 may include images of the patient or other people. For example, image bank 203 may include images of characters from a given television show or movie. Image bank 203 may also include images of the patient or their family.

After ingesting images, server 201 performs sentiment analysis on the images or associated text. For example, presented with a plurality of images of a patient, facial expression may be analyzed to determine a degree of pain. Likewise, where an image is associated with text, such as in a social media post, the text may be analyzed to determine an associated sentiment.

It will be appreciated that a variety of sentiment extraction techniques are known in the art that are applicable to images or text. For example, IBM Watson provide cloud based sentiment analysis. More generally, a learning system may be trained to perform sentiment analysis from an image or text. Such systems take in a feature vector indicative of the text or image to be analyzed and generate one or more outputs indicative of the degree of the detected sentiment.

In some embodiments, the learning system comprises a SVM. In other embodiments, the learning system comprises an artificial neural network. In some embodiments, the learning system is pre-trained using training data. In some embodiments training data is retrospective data. In some embodiments, the retrospective data is stored in a data store. In some embodiments, the learning system may be additionally trained through manual curation of previously generated outputs.

In some embodiments, the learning system is a trained classifier. In some embodiments, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

In some embodiments, the result of sentiment analysis includes a probability of each of a plurality of sentiments. For example, probabilities for anger, contempt, disgust, fear, happiness, neutral, sadness, or surprise may be output from the sentiment analysis.

Once sentiment analysis has been performed for a variety of images, the images are aligned to a pain (or other state) scale. The images are thus scored for display to a user to assist in self-assessment. In various embodiments, aligning the images to the pain scale comprises normalizing the sentiment level to the pain scale. For example, where the sentiment level is given as a percentage and the pain scale is a scale of 1-10, the images falling within each decile may be assigned to each numeric pain score.

Once the images have been scored, a group of images is selected for display, for example on mobile device 204. In some embodiments, mobile device 204 is a tablet or smartphone. However, it will be appreciated that the images may be displayed to a user via a desktop computer or other display. In some embodiments, server 201 communicates with mobile device 204 via a network 205 such as the internet. The user is able to select from among the displayed images to indicate their pain level (or other state). The images may likewise be displayed to the physician. In this way, the patient and doctor are supplied with images that are personalized or familiar, thereby increasing the context and improving communication.

In some embodiments, the pain level assessment is stored in electronic health record (EHR) repository 206. In this way, a statistical deviations in pain over time and relative to a given condition may be tracked. Similarly, these data in combination with data of other patients may be used to further train a sentiment analysis system.

An electronic health record (EHR), or electronic medical record (EMR), may refer to the systematized collection of patient and population electronically-stored health information in a digital format. These records can be shared across different health care settings and may extend beyond the information available in a PACS discussed above. Records may be shared through network-connected, enterprise-wide information systems or other information networks and exchanges. EHRs may include a range of data, including demographics, medical history, medication and allergies, immunization status, laboratory test results, radiology images, vital signs, personal statistics like age and weight, and billing information.

EHR systems may be designed to store data and capture the state of a patient across time. In this way, the need to track down a patient's previous paper medical records is eliminated. In addition, an EHR system may assist in ensuring that data is accurate and legible. It may reduce risk of data replication as the data is centralized. Due to the digital information being searchable, EMRs may be more effective when extracting medical data for the examination of possible trends and long term changes in a patient. Population-based studies of medical records may also be facilitated by the widespread adoption of EHRs and EMRs.

In various embodiments, a patient state may be recorded in this manner at regular intervals or in response to an external event. For example, to track pain throughout the day, the user may be prompted through their smartphone to indicate their pain level hourly. In another example, pre- and post-treatment patient state may be recorded.

As part of sentiment analysis, facial features may be used to determine the state of the person in the image. In addition, environmental features may be used to infer a likely state of the person in the image. For example, an image at a sporting event may be associated with a different sentiment than an image taken in an office setting. By gathering environmental features, facial features and textual features may be normalized against a population of people at a specific time and location.

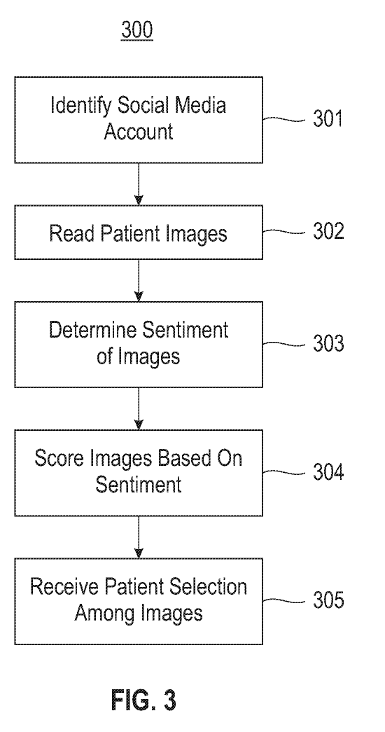

With reference now to FIG. 3, a method of patient state assessment and sharing is illustrated according to embodiments of the present disclosure. At 301, a patient identifies one or more social media accounts. In some embodiments, the patient registers these social media accounts with a central server. At 302, a plurality of images is retrieved from the one or more social media accounts.

In some embodiments, face detection is performed on the social media images to determine which show the patient's face. In some embodiments, these images are supplemented by retrieving additional images from one or more additional image bank. In some embodiments, the additional images are retrieved based on information regarding the patient taken from the social media profile. For example, images from a given movie may be retrieved based on an indication by the patient that they like that movie. Similarly, demographic information regarding the patient may be used to select additional image. For example, the age of the patient may be used to select movies that were popular in their youth, or that are popular among their age range. The patient profile may be gathered from social media, from electronic health records, or separately maintained.

In some embodiments, images may be selected on the basis of a physician's profile as well as the patient's profile. For example, where a patient and a physician like a movie in common, images may be selected from that movie. Likewise, where other commonalities exist, images may be selected accordingly. In some embodiments, the physician profile may be gathered from social media.

In various embodiments, these additional images include facial expressions of characters in subject media such as movies. This provides a contextual framework for the sentiment where the patient is familiar with the media in question.

At 303, a degree of sentiment is determined for each of the images. In some embodiments, the sentiment corresponds with a degree of pain.

At 304, the images are assigned a score based on the sentiment. In some embodiments, these scores correspond to pain. At 305, the patient selects from among the images that representing their self-assessment. In some embodiments, the images are displayed on a mobile device or other digital display. In some embodiment, the images are displayed concurrently to the patient and to the doctor to provide a shared understanding of the patient's self-assessment.

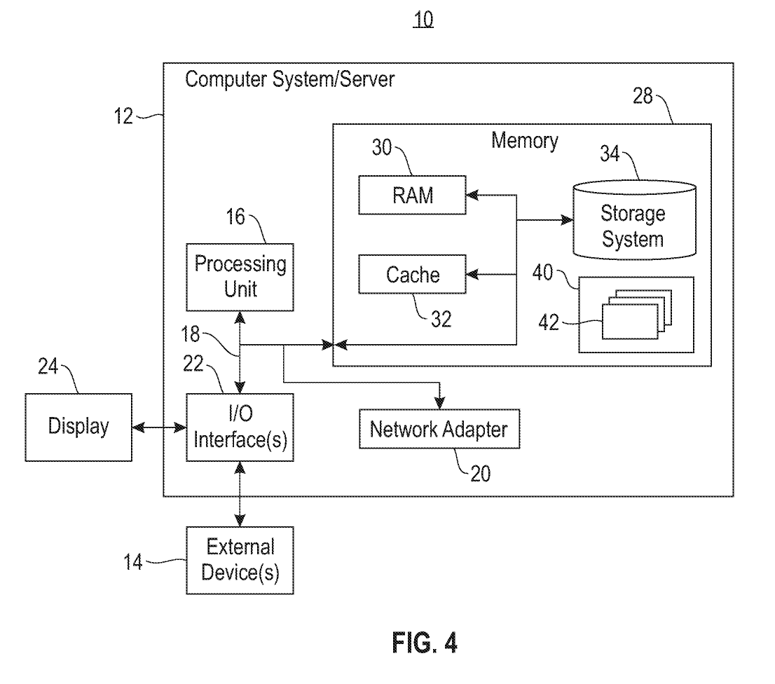

Referring now to FIG. 4, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
reading one or more image of a patient from a designated social media account;
determining one or more patient interest from the designated social media account;
selecting one or more additional image based on the one or more patient interest;
determining sentiments for the one or more image of the patient and the one or more additional image;
based on the sentiments, determining scores for the one or more image of the patient and for the one or more additional image;
displaying to the patient the one or more image of the patient and the one or more additional image;
receiving from the user a selection among the one or more image of the patient and the one or more additional image, the selection indicative of the patient's self-assessed score.

2. The method of claim 1, wherein reading the one or more image of the patient comprises determining through facial recognition that the one or more image of the patient includes the patient's face.

3. The method of claim 1, wherein selecting the one or more additional image further comprises selecting based on demographic information of the patient.

4. The method of claim 1, further comprising:
reading one or more interest of a physician, and wherein
selecting the one or more additional image further comprises selecting based on common interests of the patient and the physician.

5. The method of claim 1, wherein the scores correspond to degrees of pain.

6. The method of claim 1, further comprising:
storing the one or more image of the patient and the one or more additional image and the associated scores to an electronic health record of the patient.

7. The method of claim 1, further comprising:
displaying to a physician the one or more image of the patient and the one or more additional image.

8. The method of claim 1, wherein determining sentiments for the one or more image of the patient and the one or more additional image comprises applying a learning system.

9. The method of claim 8, wherein the learning system comprises an SVM or an ANN.

10. The method of claim 1, wherein displaying the one or more image of the patient and the one or more additional image comprises displaying on a mobile device.

11. A system comprising:
a computing node comprising a computer readable storage medium having program instructions embodied therewith, the program instructions executable by a processor of the computing node to cause the processor to perform a method comprising:
reading one or more image of a patient from a designated social media account;
determining one or more patient interest from the designated social media account;
selecting one or more additional image based on the one or more patient interest;
determining sentiments for the one or more image of the patient and the one or more additional image;
based on the sentiments, determining scores for the one or more image of the patient and for the one or more additional image;
displaying to the patient the one or more image of the patient and the one or more additional image;
receiving from the user a selection among the one or more image of the patient and the one or more additional image, the selection indicative of the patient's self-assessed score.

12. A computer program product for patient state assessment, the computer program product comprising a computer readable storage medium having program instructions embodied therewith, the program instructions executable by a processor to cause the processor to perform a method comprising:
reading one or more image of a patient from a designated social media account;
determining one or more patient interest from the designated social media account;
selecting one or more additional image based on the one or more patient interest;
determining sentiments for the one or more image of the patient and the one or more additional image;
based on the sentiments, determining scores for the one or more image of the patient and for the one or more additional image;
displaying to the patient the one or more image of the patient and the one or more additional image;
receiving from the user a selection among the one or more image of the patient and the one or more additional image, the selection indicative of the patient's self-assessed score.

13. The computer program product of claim 12, wherein reading the one or more image of the patient comprises determining through facial recognition that the one or more image of the patient includes the patient's face.

14. The computer program product of claim 12, wherein selecting the one or more additional image further comprises selecting based on demographic information of the patient.

15. The computer program product of claim 12, the method further comprising:
reading one or more interest of a physician, and wherein
selecting the one or more additional image further comprises selecting based on common interests of the patient and the physician.

16. The computer program product of claim 12, wherein the scores correspond to degrees of pain.

17. The computer program product of claim 12, the method further comprising:
storing the one or more image of the patient and the one or more additional image and the associated scores to an electronic health record of the patient.

18. The computer program product of claim 12, the method further comprising:
displaying to a physician the one or more image of the patient and the one or more additional image.

19. The computer program product of claim 12, wherein determining sentiments for the one or more image of the patient and the one or more additional image comprises applying a learning system.

20. The computer program product of claim 19, wherein the learning system comprises an SVM or an ANN.
